(19) United States
(12) Patent Application Publication
(10) Pub. No.: US 2013/0339080 A1
(43) Pub. Date: Dec. 19, 2013

(54) BUILDING SYSTEM CONTROL AND EQUIPMENT FAULT AND DEGRADATION MONETIZATION AND PRIORITIZATION

(71) Applicant: Honeywell International Inc., Morristown, NJ (US)

(72) Inventors: Conrad Bruce Beaulieu, Duluth, MN (US); Greg Bernhardt, Hopkins, MN (US); Jiri Rojicek, Prague (CZ)

(73) Assignee: Honeywell International Inc., Morristown, NJ (US)

(21) Appl. No.: 13/969,417

(22) Filed: Aug. 16, 2013

Related U.S. Application Data
(63) Continuation of application No. 13/052,925, filed on Mar. 21, 2011.

(51) Int. Cl. G06Q 10/06

(52) U.S. Cl. CPC G06Q 10/06315
USPC 705/7.25

(57) ABSTRACT

An approach for monetizing performance of building system equipment such as HVAC equipment. Expected and actual performance curves may be obtained for the HVAC equipment. Differences between the curves may indicate energy consumption. The energy consumption may be monetized. The monetizing may be of degradation that occurs when the equipment deteriorates, incurs a fault or has a loss of performance as accrued over time. Monetizing may incorporate maintenance and capital risk exposure. The monetizing may be a conversion of analyses of the equipment to money in real time. Performance monitoring of the equipment may incorporate predictive trending which may lead to fault prognosis and preventative maintenance. Automation of the conversion may result in immediate information and feedback to customers. The information may be stored for historical purposes and future analyses.

This application is a continuation application of U.S. patent application Ser. No. 13/052,925, filed Mar. 21, 2011, and entitled “ BUILDING SYSTEM CONTROL AND EQUIPMENT FAULT AND DEGRADATION MONETIZATION AND PRIORITIZATION”. U.S. patent application Ser. No. 13/052,925, filed Mar. 21, 2011, is hereby incorporated by reference.

### BACKGROUND

The present disclosure pertains to building control systems, the system's mechanical, electrical and sensing equipment and particularly to HVAC equipment. More particularly, the disclosure pertains to conditions of the equipment and its control.

### SUMMARY

The present disclosure reveals an approach to monetize the performance of building system equipment such as HVAC or lighting equipment. Expected and actual performance curves may be obtained for the system as a whole and its equipment. Differences between the performance curves may indicate excessive energy consumption. The excessive energy consumption may be monetized using demand variable rate prices. The monetization may include degradation that occurs when the equipment deteriorates, incurs a fault or has a natural loss of performance as accrued over time. Monetization may incorporate maintenance, overall system sustainability, and capital risk exposure. Monetization may feature a conversion of equipment analysis to money in real-time. Performance monitoring of the equipment may incorporate predictive trending which may lead to fault prognosis and preventive maintenance. Automation of the conversion may result in immediate actionable information and feedback to customers and service personnel. The information may be stored for historical purposes and future analyses.

### BRIEF DESCRIPTION OF THE DRAWING

FIG. 1 is a diagram of an overview of observation evaluation of HVAC and lighting equipment;

FIG. 2 is a diagram of an air handling unit showing pertinent data;

FIGS. 3a, 3b, 3c and 3d are graphs illustrating fault isolation and/or root cause identification of an HVAC system. Faults in a lighting subsystem could be similarly identified;

FIG. 4 is a diagram of a graph that shows fault isolation of an air handling unit shown in terms of fault relevance development over time;

FIG. 5 is a diagram of a graph that shows boiler efficiency degradation;

FIG. 6 is a diagram of graphs showing three-dimensional performance maps for a chiller at full and partial loads;

FIG. 7 is a diagram of a table showing an example of boiler efficiency degradation;

FIG. 8 is a diagram of a graph showing an illustrative example of actual costs compared to an expected baseline cost for a boiler operation;

FIG. 9 is a diagram of an on-line graphical user interface screen print of a display showing an illustrative example of live and/or actual equipment performance of a boiler;

FIG. 10 is a diagram of a plot of an illustrative example of damper position versus an air handling unit heating and cooling demand;

FIG. 11 is a diagram of a plot of pressure in a supply duct after the supply filter versus a control signal of the supply fan in percent;

FIG. 12 is a diagram of a three-dimensional demand overview graph of an air handling unit;

FIG. 13 is a diagram of a hierarchy of items having detected results which may be indicated in a visualization of levels of enterprises, plants, equipment and components of a building management system;

FIG. 14 is a diagram of a graph of an illustrative example showing energy wasted represented by a shaded area under the curve of, for instance, a cooling system;

FIG. 15 is a diagram of a graph indicating a set of characteristics for an example chilled water valve;

FIG. 16 is a diagram of a graph showing flow versus opening for a variety of example valves;

FIG. 17 is a diagram of a table showing data for an example chiller;

FIG. 18 is a diagram of an approach for monetizing performance of building system equipment;

FIG. 19 is a diagram of an approach for monetizing degradation of building system equipment; and

FIG. 20 is a diagram of a monetization system for evaluating building system equipment.

### DESCRIPTION

The commercial issue is an understanding in monetary terms exactly how much money building equipment faults and degradation is costing when a fault occurs or degradation is detectable, as accrued over time, and in terms of maintenance backlog and capital risk exposure. The technical issue may be an advanced analysis and correlation of large and complex data sets over time with an understanding of the building and equipment operational context. Results of an analysis may need to then be converted to money in real-time and stored for historical purposes. An input to this calculation may incorporate a cost of energy, variable fuel rates, and so forth. Automation of these conversions may result in immediate feedback to the customer and to a company (e.g., Honeywell International Inc.) service organization.

A measurement and verification (M&V) business may perform many of the monetization tasks through a manual analysis process. Much of the potential analysis value cannot necessarily be captured and the results of the analysis may often be delayed from several months to a year.

Financial decisions related to the system may be made immediately resulting in retrofit and re-commissioning activities that are both manual and can be automated to some degree. After corrections are made, the anticipated results may be validated and the promised energy usage savings realized. Also events that prevent the total realization of savings from occurring may be identified through continuous monitoring.

The present approach may encapsulate the fortunate convergence of many technologies and analysis approaches. These may incorporate combining the probabilistic identification of anomalies with detailed modeling of equipment behavior, equating certain equipment performance characteristics with wasted energy usage and multiplying the wasted energy amount against an energy rate, having a large set of equipment and system performance data available to test the equipment models, and having experienced energy analysts to help prioritize the savings opportunities.

The present approach may be realized in a building optimization services solution. The solution may be achieved through the integration of several sub-systems and services. They may incorporate building management service, building usage profiles, occupant comfort metrics, data acquisition, data normalization in a data warehouse, models for the data, data relationships, equipment models, advanced field device diagnostics and a costing engine based on probabilistic findings.

The present disclosure may relate to an HVAC (heating, ventilation and air conditioning) and lighting diagnostics program. Remote diagnostics of a building's energy system performance may fit into a business optimization service. “Remote” means that the diagnostics may run on a remote server or at any other place where virtually all necessary data are available. There may be algorithms for automated fault detection and diagnostics (AFDD), anomaly detection and localization, degradation detection and measurement, and possible fault isolation.

Performance monitoring of HVAC equipment may incorporate performance predictive trending that can lead to fault prognosis.

Practical aspects may be addressed. There may be scenarios for different levels of instrumentation (e.g., available sensors). Lost equipment performance may be translated to a cost of degradation in terms of energy usage and equipment lifetimes.

Various types of HVAC faults may occur. There may be hardware faults due to human errors. For instance, design faults may involve incorrect sizing of coils and duct work, inappropriate location of sensors, incorrectly specified control logic, and so on. Construction and assembly faults may involve erroneous wiring, reverse rotational direction of a fan, and so on. Operational and maintenance faults may involve faulty manual settings, opened windows, poor servicing, and so on.

There may be control system faults and incorrect strategy. An example of system faults may involve incorrect PID (proportional, integral and derivative) controller parameters. Incorrect strategy may involve wrong set points, sequencing logic, incorrect point assignments, and so on.

Hardware faults may incorporate abrupt faults such as component failure, malfunction, and the like. An example of degradation faults may involve performance deterioration. Sensor faults may result from broken connections, external noise, sensor drift caused by ageing, and so on.

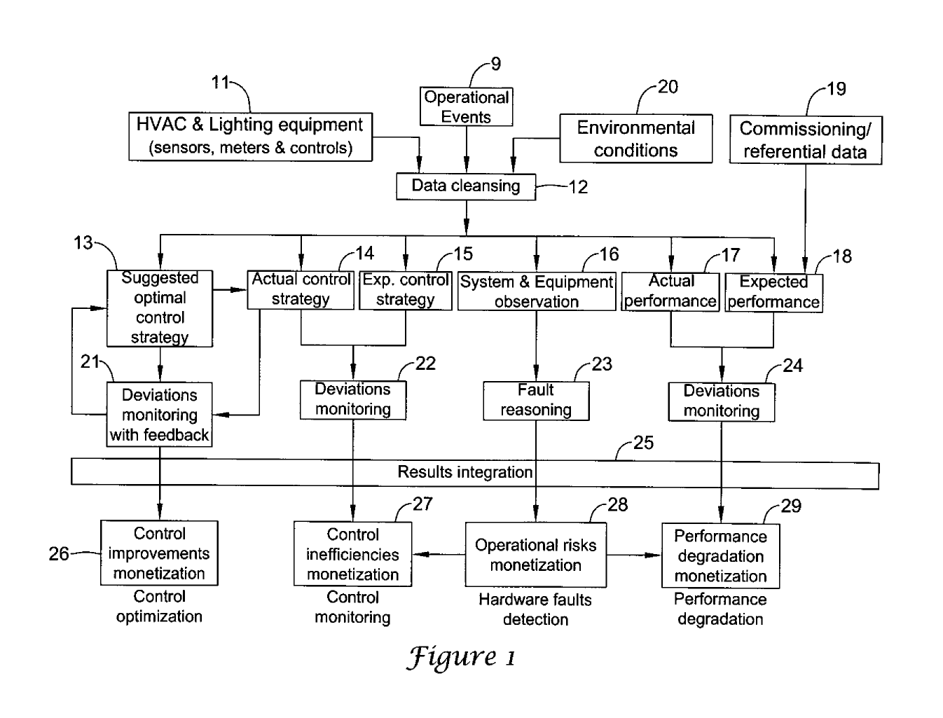

FIG. 1 is a diagram of an overview of observation evaluation of building management system equipment. A symbol 11 representing the HVAC and lighting equipment such as sensors and controls may provide information which is subject to data cleansing at symbol 12. Environment conditions from symbol 20 may also be subject to data cleansing. The data from symbol 12 may go to symbol 13 representing suggested optimal control strategy, symbol 14 representing actual control strategy, symbol 15 representing expected control strategy, symbol 16 representing system observation, symbol 17 representing actual performance and symbol 18 representing expected performance. An output from symbol 19 representing commissioning and referential data may go to symbol 18. Referential data may incorporate fuel rates, building usage profile, equipment performance models, building and equipment hierarchy, and so on.

An output from the suggested optimal control strategy at symbol 13 and an output from actual control strategy at symbol 14 may go to a symbol 21 representing deviations monitoring. An output from the deviations monitoring at symbol 21 may be fed back to the suggested optimal control strategy at symbol 13. Outputs from the actual control strategy at symbol 14 and the expected strategy at symbol 15 may go to a symbol 22 representing deviations monitoring. An output from system observation at symbol 16 may go to a symbol 23 representing fault reasoning. Outputs from actual performance at symbol 17 and expected performance at symbol 18 may go to deviations monitoring at symbol 24. The outputs from symbols 21, 22, 23 and 24, representing deviations monitoring, deviations monitoring, fault reasoning and deviations monitoring, respectively, may go via a results integration represented by symbol 25 to control improvements monetization at symbol 26, control inefficiencies monetization at symbol 27, operational risks monetization at symbol 28 and performance degradation monetization at symbol 29, respectively. Integration results at symbol 25 may have the data required to perform systemic results analysis driven by a set of rules. There may be a correlation of control and equipment findings in the context of their interconnection. Results integration may involve prioritization. Outputs from operational risks monetization at symbol 28 may go to control inefficiencies at symbol 27 and performance degradation monetization at symbol 29. The control improvements monetization at symbol 26, control inefficiencies monetization at symbol 27, operation risks monetization at symbol 28 and performance degradation monetization at symbol 29 may overall provide for control optimization, control monitoring, hardware faults detection and performance degradation, respectively.

Hardware faults may be reviewed. Mechanical faults may involve inefficiencies caused by an equipment malfunction. A malfunction may be detected in the data stream of sensor readings and control signals that are automatically processed by a service (e.g., fault detection and diagnosis) running on equipment or a control device. Instances may involve a leaking cooling coil, stuck cooling coil, stuck heating coil, leaking heating coil, general heating failure, general cooling failure, stuck economizer damper, communication failure, fan failure, stuck fuel valve, burner fan malfunction, undersized boiler, oversized boiler, controller error, wrong synchronization, wrong fan/pump interlock, marginal ballast, and so forth.

A process for fault detection may incorporate measured data points (system observation) that define a system state (mostly rules-based). Faults may be isolated from system states (observations) through fault reasoning. Fault relevance may be provided for each fault. Detection may depend on available data points. Fewer data points may mean fewer detectable faults.

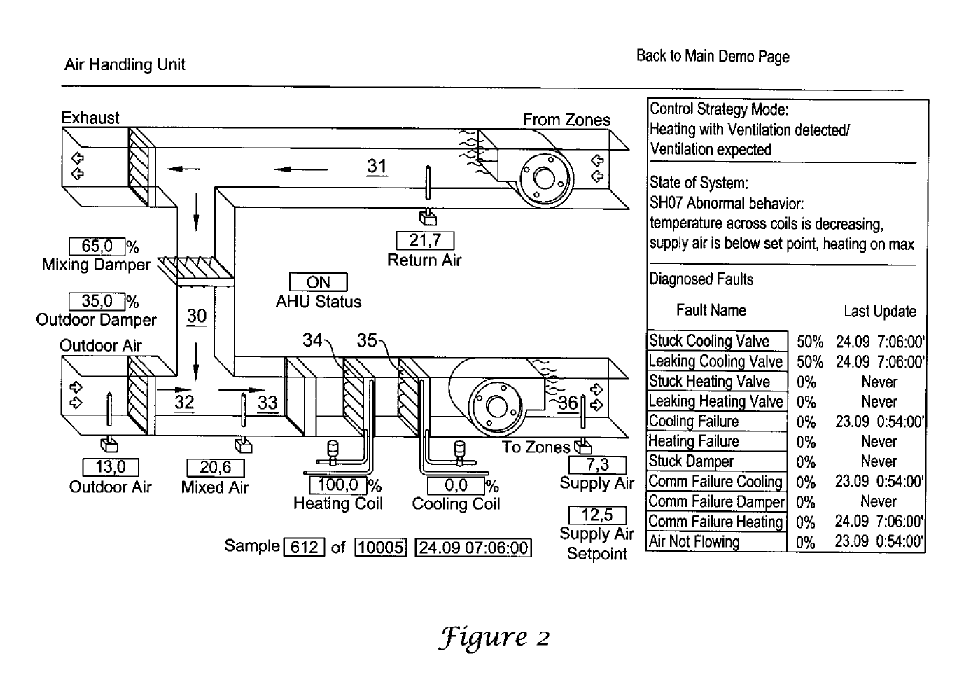

NiagaraAX™ may provide automated fault detection and diagnostics for an AHU (air handling unit). This may relate to FIG. 2. An on-line GUI (graphical user interface) (NiagaraAX) may show actual fault relevance for each fault. A Matlab™ prototype+PCT (profile creation tool) demo in NiagaraAX (TRL-3) may be used. “TRL” may refer to “technology readiness level”.

FIG. 2 is a diagram of an air handling unit with pertinent analytical data shown. Temperatures mentioned herein are illustrative instances. Return air 31 may be coming in from various zones at a temperature of about 21.7 deg. C. Outdoor air 32 may be coming in at about 13 deg. C. and being mixed with return air 30 with the mixing damper permitting 65 percent and the outdoor damper permitting 35 percent for an air mixture 33 at a temperature of about 20.6 deg. F. It may be noted that the return air behind and in front of the damper may be of different temperatures. The air 33 may go through a heating coil 34 which is supposedly on at 100 percent and through a cooling coil 35 which is supposedly on at zero percent. Mixed air 33 may be provided to the zones as supply air 36. Supply air 36 may be at about 7.3 deg. C. and the set point may be at about 12.5 deg. C. A state of the system may indicate SHOT abnormal behavior temperature across coils is decreasing, the supply air temperature is below set point, and the heating is on maximum.

A list of diagnosed faults may be shown with probabilities for an occurrence of the each fault. The list in the example of FIG. 2 may incorporate a stuck cooling valve, leaking cooling valve, stuck heating valve, leaking heating valve, cooling failure, heating failure, stuck damper, comm. failure cooling, comm. failure damper, comm. failure heating, and air not flowing. In this instance, virtually all have zero percent of probability except for the stuck cooling valve and the leaking cooling valve of which each has about a 50 percent probability of occurrence may not always be regarded for a total of about 100 percent.

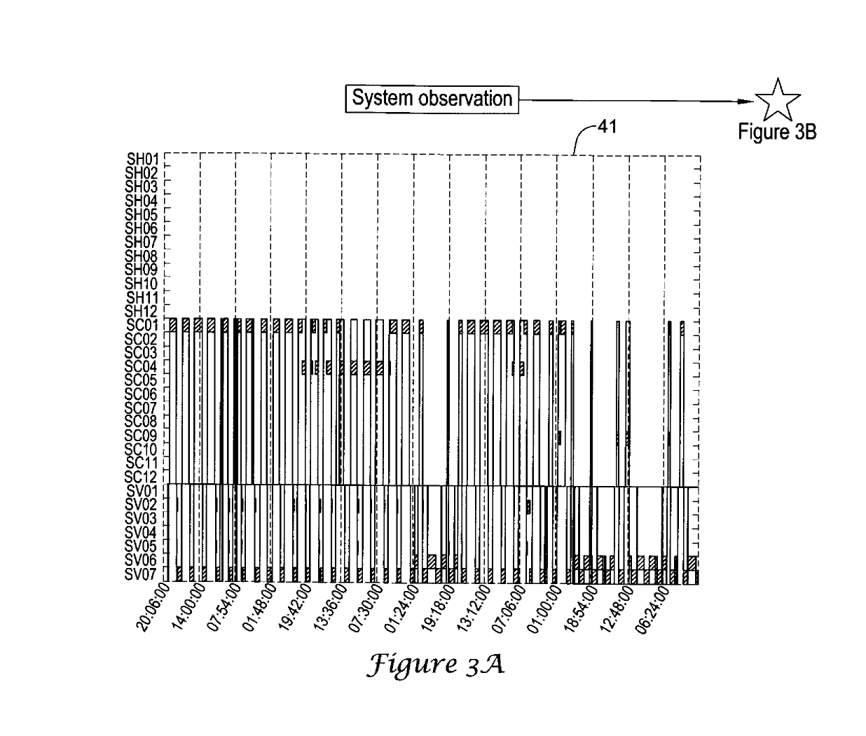

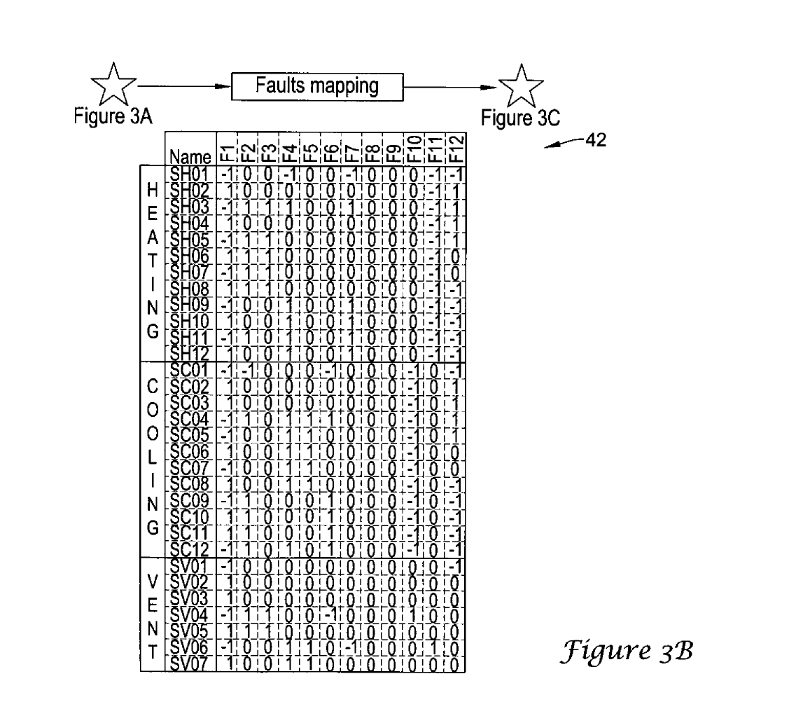

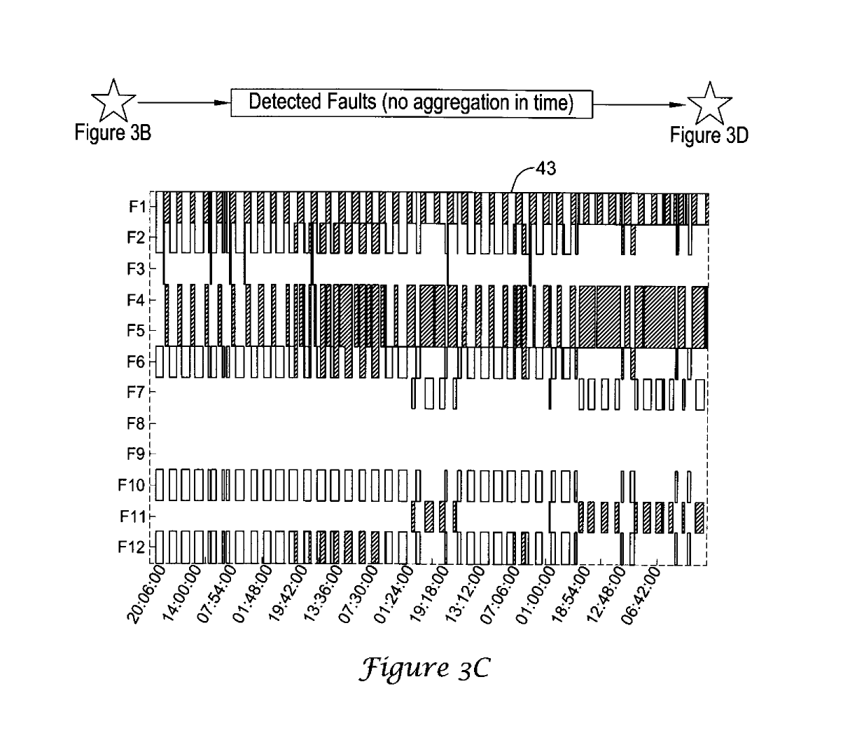

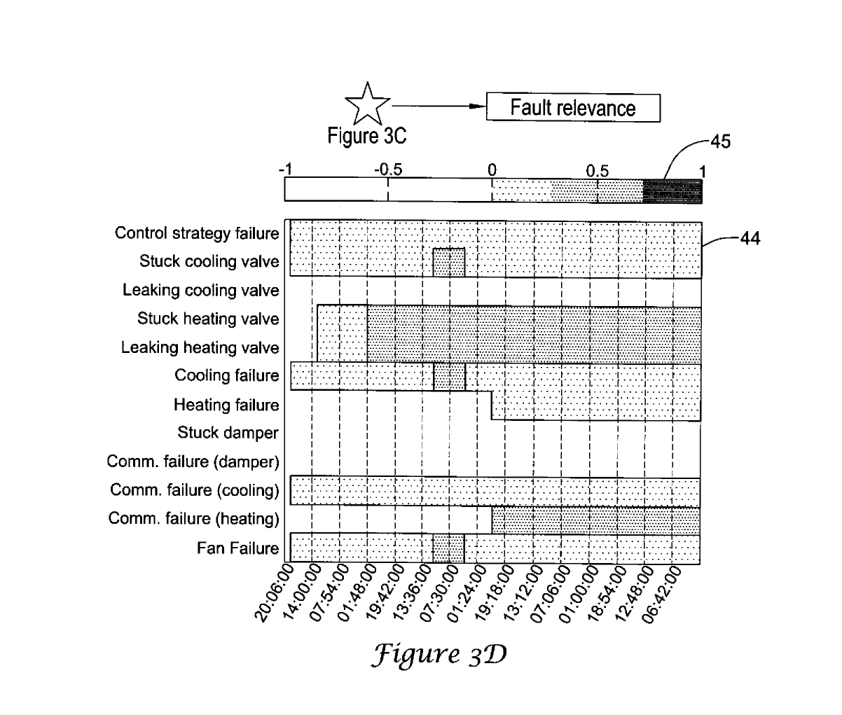

Fault-isolation and root-cause identification (fault reasoning) 23 is illustrated by graphs in FIGS. 3a, 3b, 3c and 3d. System observation may be recorded in a graph 41 of FIG. 3a with shading indicating the component on the left of the graph versus time of occurrence of performance at the bottom of graph 41. The faults may be mapped according the category of heating, cooling and ventilation with the component on the left and the fault at the top with a value of occurrence indicated by a +1, 0 or −1 in the grid of a graph 42 of FIG. 3b. The sequence of graphs continues on to graph 43 of FIG. 3c showing the fault designation on the left versus a time of fault detection indicated by a distinct bar of shading with no aggregation in time. The sequence continues on to graph 44 of FIG. 3d which shows a fault listed on the left and its relevance in the graph versus time at the bottom. The shading may indicate an amount of relevance from −1 to +1 according to a bar 45 showing the shading or color indicating the relevance of a fault.

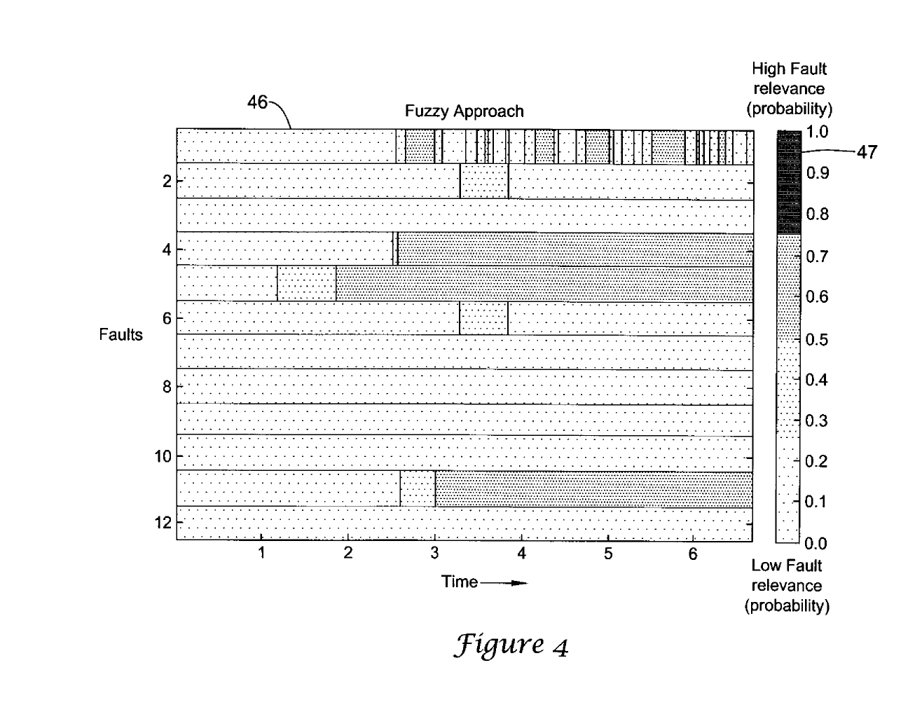

For reporting purposes, results may be archived over a significant time period. Fault isolation of an AHU may be shown in terms of fault relevance development over time which may be visualized with a graph 46 in FIG. 4. The faults are listed on the left versus significant unit periods of time at the bottom of graph 46. For each fault at a particular time period, a high fault relevance in terms of probability may be indicated on the graph for each intersection of a fault block and time period by a shading or color. Bar 47 is a key indicating shading or color for each probability from 0.0 to 1.0. The layout, the plotting and conclusions of the graph may use a result of a fuzzy logic approach.

Operational risks 28 may be reported. Operational risks are not necessarily directly detected, but may be derived from detected faults based on expert knowledge. An example of a symptom may be a ChW (chilled water) pump is unnecessarily cycling ON and OFF while the compressor is OFF. A detected fault may be a wrong interlock of compressor and chilled water pumps. An explanation or consequence is that repeated frequent ChW pump cycling may shorten the pump's life. An impact may be high operational cost and a high operational risk.

Another example of a symptom may be that the chiller pump is operating without a load. The detected fault may be a wrong interlock of compressor and chilled water pumps. An explanation may be that the chiller is operating without a load and thus damage to the compressor may result. The impact may be high operational cost and a high operational risk. Similarly, based on expert knowledge, maintenance actions may also be recommended.

Performance degradation 29 may be looked at. Equipment performance monitoring may aid in determining degradation. Equipment performance measures may be continuous numerical metrics that allow an assessment of current equipment performance, a comparison of the performance with an “ideal performance” (i.e., a model) that can correspond, e.g., to the maximum design performance determined by the vendor of the equipment.

Examples of performance measures may include coefficient of performance (COP), energy efficiency ratio (EER), boiler efficiency, chiller efficiency, heating and cooling coil fouling factors, and pressure drop on the air filter. The fouling factors may be in terms of h*ft² ° F/Btu units or m2*° C./W units. Heat transfer efficiency may be noted.

Performance measures 18 may slowly deteriorate in time as a result of equipment degradation caused, e.g., by degradation mechanisms like particle fouling, clogging, animal or insect invasion, or mechanical wearing. If a performance measure reaches specific threshold, maintenance actions should be applied, e.g., cleaning or repair. A difference between actual and ideal performance measures may be translated to a cost of degradation.

There may various types of performance measures. Performance measures (PM) may be defined at 1) a component level, e.g., heating or cooling coil fouling rate, equipment level, e.g., coefficient of performance (COP), or energy efficiency ratio (EER), and 3) zone, floor, building or other level.

A reference behavior (model) 19 may be considered. It may be defined by a manufacturer which could be applicable for some equipment only. A rigorous performance measure may be based on first principles (e.g., thermodynamic laws, mass and energy balances) and the equipment should be adequately instrumented since much data are likely to be needed. This approach appears to be the most accurate way to assess equipment performance.

An empirical performance measure 19 may be based on empirical relations among key equipment parameters. Usually less data may be needed for calculation. Such performance measure may incorporate benchmarking, base-lining, and the like. It may also incorporate best known behavior (typically commissioning).

Performance measures of, for example, AHU coils of varying different complexity may be reviewed. One performance measure may be supply air temperature (t) which can be directly measured. A formula used in calculating such measurement may be t_{SUPPLY}=f (t_{MIXED}, u_{CC}). “u” may be a heat transfer coefficient. Sensors and parameters needed may be for two temperatures and a valve control signal.

Another performance measure may be heat transfer efficiency. The measurement may involve an empirical NTU (number of transferred units) approach. A formula used in calculating the measurement may be ε=(t_{air,in}-t_{air,out})/t_{air,in}-t_{water,in}). The sensors and parameters needed may be for three temperatures (t).

A first principle related to an AHU performance measure may incorporate a heat transfer coefficient or fouling resistance. A calculation approach would be a first principle model of a heat exchanger. The formulas used in calculating a measurement may be Q=UAΔTₗₙ, Q=m_{S}C_{P}(t_{C}-t_{M}), Q=m_{CW}c_{P,CW}(t_{OUT,CW}-t_{IN,CW}) and R_{f}=(1/Uₐ)-(1/U_{c}). The sensors and parameters needed may be four temperatures, and two flow rates in the heat exchange area. The accuracy, computational complexity and sensor/data requirements may increase with the progression of the three noted examples for performance measurements.

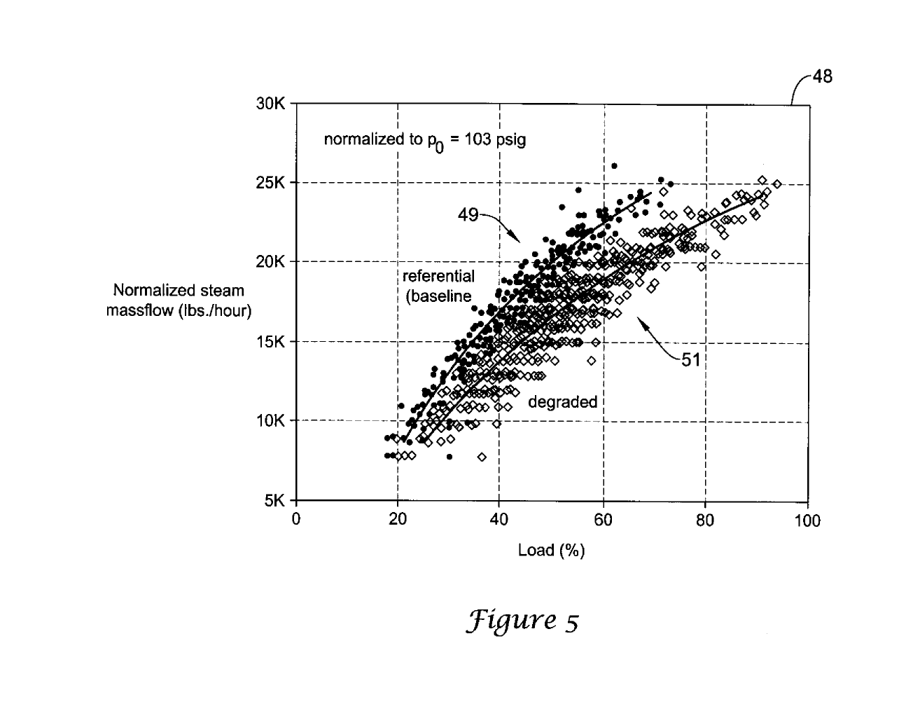

Boiler efficiency degradation may be illustrated by a graph 48 in FIG. 5. Graph 48 shows boiler efficiency degradation with a plot of data for normalized steam massflow (lbs/hour) versus load in terms of percentage. The data may be normalized to p₀=103 psig. A plot of the degradation data represented by a curve 51 is contrasted against a plot of referential (baseline) data represented by a curve 49. Mechanisms of degradation may include burner fouling, dirt accumulation, clogging on the water side of the boiler, and other like deteriorating aspects of the boiler system. Degradation cost may involve for instance more fuel (e.g., gas) needed to achieve the same heating supply which has a direct impact on bills for fuel. Referential behavior may be a model typically defined by commissioning data for boilers. A first principle model noted herein may be useful but possibly complex for practical purposes.

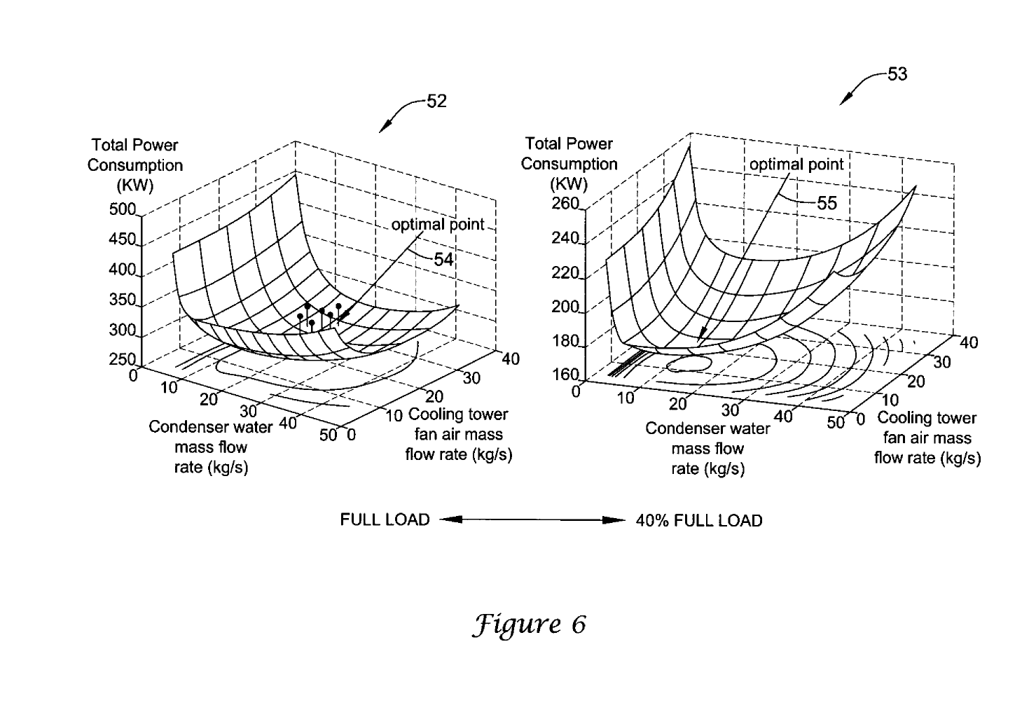

FIG. 6 shows chiller three-dimensional performance maps 52 and 53. The maps show total power consumption (KW) (Y axis) versus condenser water mass flow rate (kg/s) (X axis) versus cooling tower fan air mass flow rate (kg/s) (Z axis). Map 52 is a plot of the indicated parameters for a full load (Q_{load}=Q_{load}_{_{—}}ᵣₐₜₑ) showing an optimal point 54 Map 53 is a plot of the indicated parameters for 40 percent of full load (Q_{load}=0.4*Q_{load}_{_{—}}ᵣₐₜₑ) showing an optimal point 55. The cost of chiller degradation means that more energy is needed to achieve the same cooling load. More energy usage may have a direct impact on energy bills

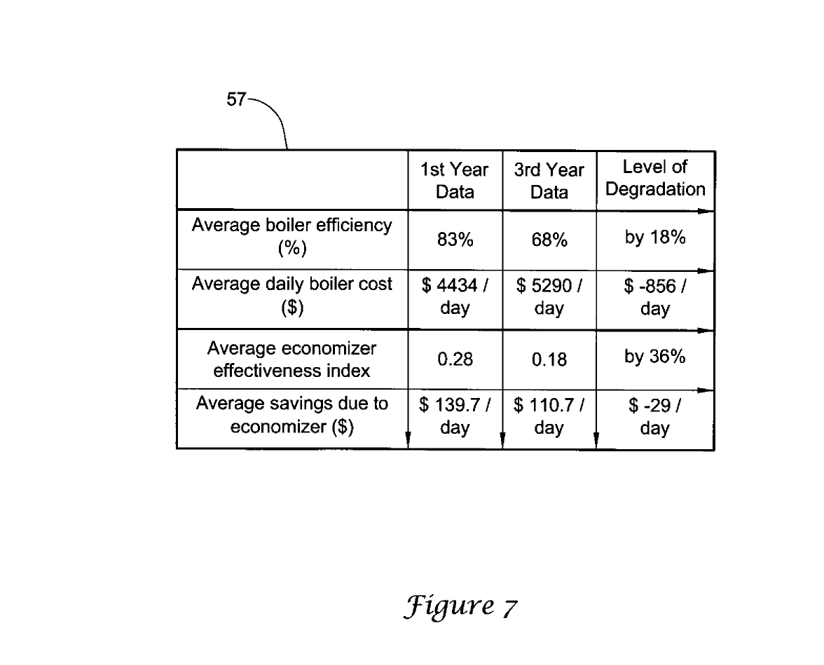

FIG. 7 is a diagram of a table 57 showing an example of boiler efficiency degradation 29. Average boiler efficiency from a set of data from a first year of operation may be 83 percent and from a third year of data may be 68 percent with a level of degradation of 18 percent. An average daily boiler cost may be $4434 per day in the first year and $5290 per day in the third year resulting in degradation loss of $856 per day of operation. Weather normalization using degree days may be used to perform comparisons. It may be noted that if the boiler efficiency were about 100 percent, the average daily cost would be about $3465 per day. For each instance of degradation, that would amount to a cost increase of about $57 per degree of degradation per day.

An average economizer effectiveness index may be 0.28 for the first year and 0.18 for the third year resulting in a degradation of 36 percent. The average savings due to the economizer may be $139.7 per day for the first year and $110.7 per day for the third year resulting in a degradation loss of $29 per day.

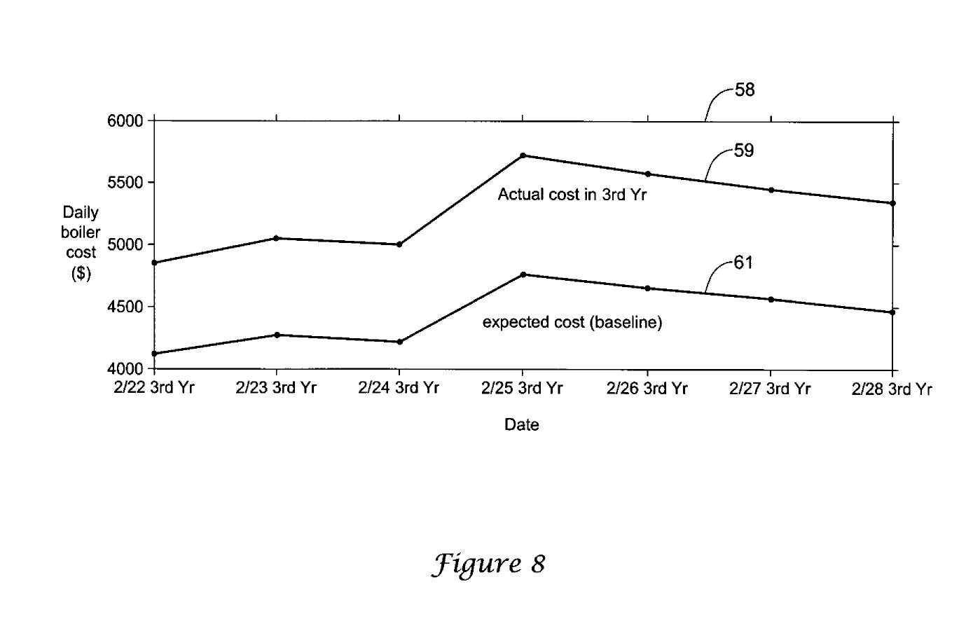

A graph 58 in FIG. 8 shows an illustrative example which may incorporate actual costs during a week in February of a third year compared to an expected baseline cost for boiler operation. Graph 58 shows daily boiler cost versus day. A plot 59 of the cost and a plot 61 of expected cost in the graph may reveal an overall detected degradation of boiler operating efficiency.

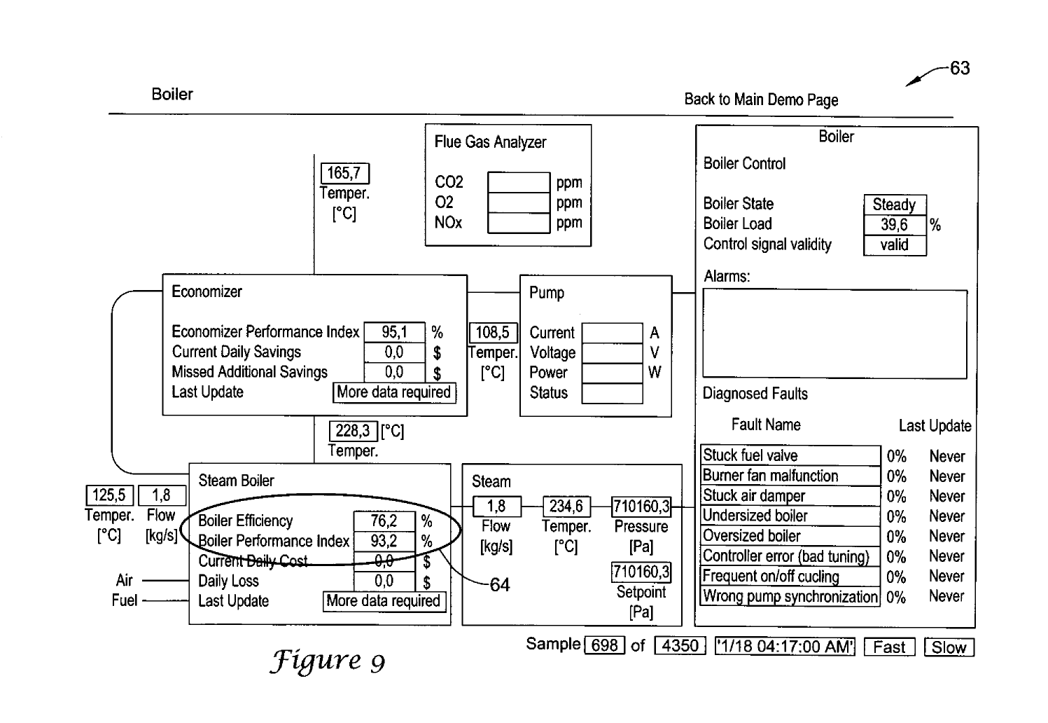

FIG. 9 is a diagram of an on-line graphical user interface (Niagara AX™) screen print of a display 63 that may show live and/or actual equipment performance of a boiler. For instance of a steam boiler, a highlighting oval 64 shows a boiler efficiency of 76.2 percent and a boiler index of 93.2 percent for a steam boiler. Various other boiler parameters may be shown in display 63. A setup for such display may involve a Matlab™ prototype plus a profile creation tool demo in Niagara AX (TRL-3). A suitable pilot (TRL-6) may be looked for.

Monetization of faults may be looked at according to type. If the fault type is a complete failure, then the impact on costs and replacement may be a one time cost for repair or replacement and the comfort level may be unsatisfactory for some time. Approaches here may involve reliability engineering and evaluation of operational risks.

If the fault type is a mechanical or control system one, then the HVAC system may operate less efficiently resulting in higher operating costs. Also, once the fault is detected and diagnosed, it may cause a one time cost for repair or replacement. The comfort level may depend on the ability of the system to compensate that fault. An approach may incorporate fault detection and diagnosis. Monetization may be difficult on the component level. However, global performance measures may be used.

If the fault type is performance degradation, the HVAC may operate less efficiently with operating costs slowly increasing. There may be a one time cost for maintenance, servicing and/or cleaning. The comfort level may depend on the ability of the system to compensate for that degradation. Typically, comfort may not necessarily be affected. An approach may be historical performance monitoring. Monetization may involve using equipment/component specific performance measures.

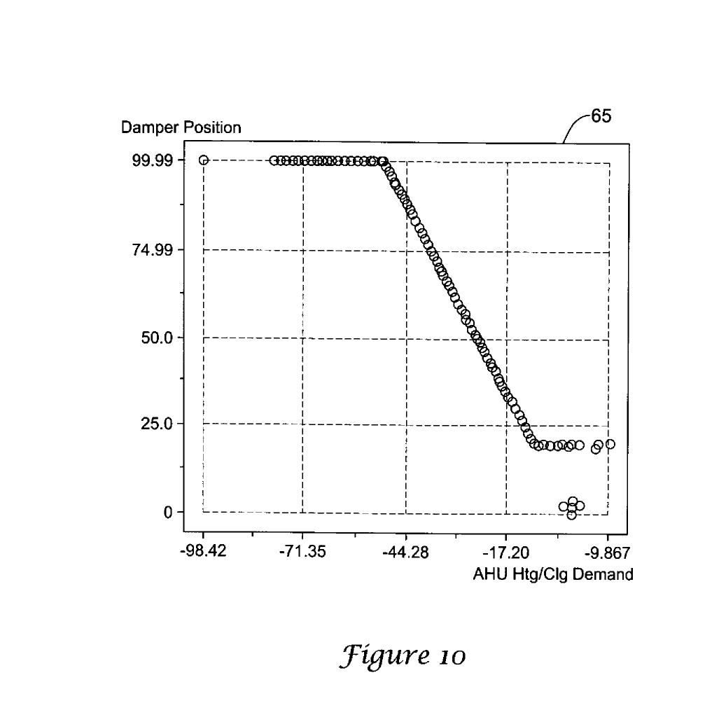

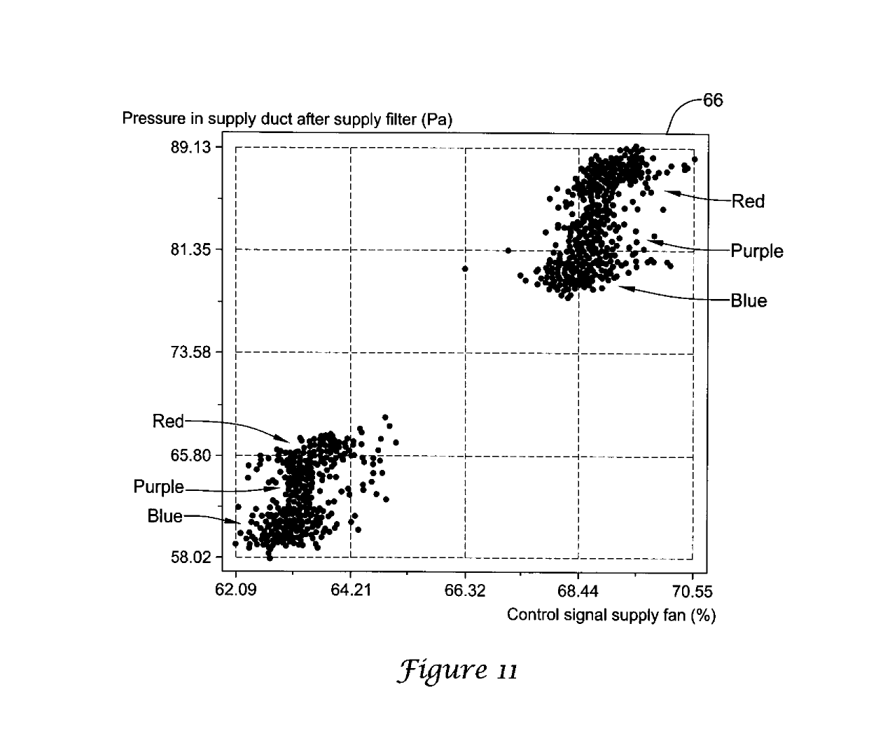

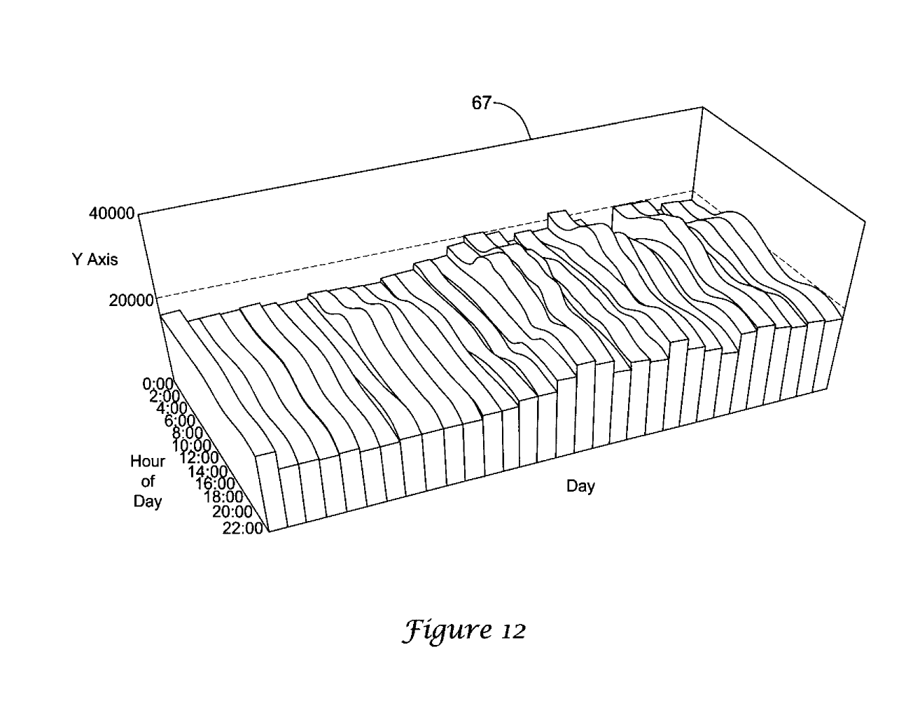

Diagnostic plots 16 may be used to illustrate typical dependencies among key variables and parameters. Plots may be used to assess behavior of equipment, its components, and associated control loops. The plots may be equipment-specific (i.e., focused on, e.g., AHU), and possibly be also component-specific (i.e., focused on an economizer, a mixing box, and so forth). Fault detection and diagnosis may be done manually. Examples of plots are shown in FIGS. 10, 11 and 12. FIG. 10 is a plot 65 of damper position versus AHU heating and cooling demand. FIG. 11 is a plot 66 of pressure in a supply duct after the supply filter (Pa) versus a control signal of the supply fan in percent. The plot may reveal closed outliers, and/or clogging such as that of a filter. Possible degradation may be indicated, e.g., a pressure loss with a similar percentage of a control signal. FIG. 12 shows a demand overview. The FIG. 12 is a plot 67 of demand versus hour of the day versus day. Patterns of these plots may reveal various conditions of certain components of an AHU.

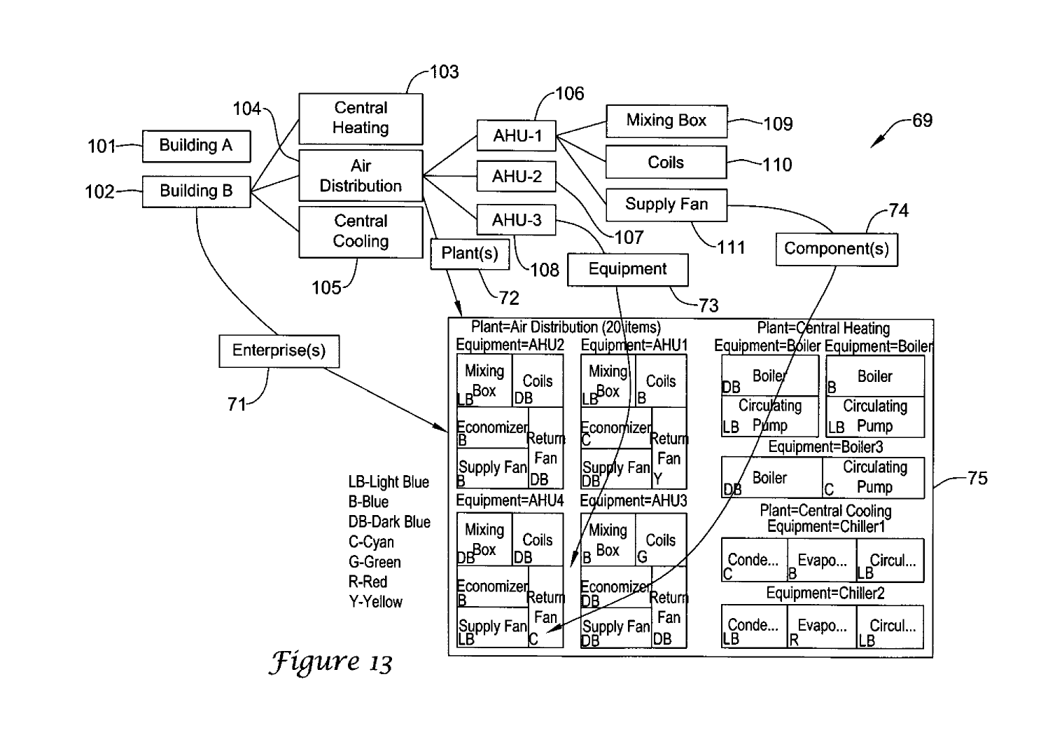

Detected results may be visualized in a clear and concise way. An example of a visualization may be shown as a relational diagram 69 in FIG. 13. A hierarchy of items of results may be indicated, for example, in levels of 1) enterprises 71, such as buildings 101 and 102, 2) plants 72, such as central heating 103, air distribution 104 and central cooling 105, 3) equipment 73, such as AHUs 106, 107 and 108, and 4) components 74, such as a mixing box 109, coils 110 and a supply fan 111. The hierarchy of items may have various structures and levels. Diagram 75 may show an example layout of the items of the hierarchy.

The colors may indicate a fault status probability. The estimated energy waste in terms of money may be indicated by text in the equipment boxes. The size of the colored box in this tree map indicates energy consumption in money or relevant units associated with the equipment type.

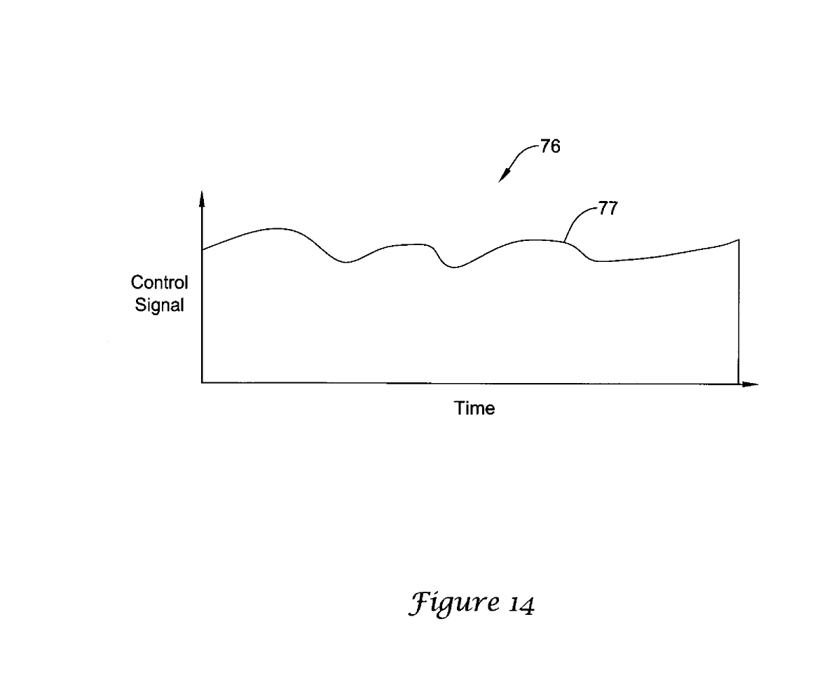

Control inefficiency monetization 27 may be automatically computed from monitoring actual control behavior, comparing this to expected behavior and optimal behavior if the context is modeled. Control may be affected by equipment degradation. This may incorporate operational risk and control. Costs of an inefficient system may be equivalent to money=(energy wasted)*(energy price). Energy price may be money/kWh (Btu, or other unit) at $0.1/kWh. Total energy wasted may be represented by a shaded area under a curve 77 in a graph 76 of FIG. 14. The graph represents control signal versus time. One may determine actual versus optimal control strategy curves with a difference highlighted, and thus have a description of optimal control strategy.

Energy loss (E) (i.e., energy transferred to air) may be calculated as E=(t_{chilled}_{_{—}}_{water}_{_{—}}_{supply}-t_{chilled}_{_{—}}_{water}_{_{—}}ᵣₑₜᵤᵣₙ)*(chilled_{—}_{water}mass_flow)*(specific_water_capacity). In cooling and heating, a control signal may open and close the chilled water valve. The valve position or mass flow dependency may determine the chilled water mass flow. The chilled water supply and return temperatures may be determined. Chilled water supply and return temperatures are generally necessary for monetization (or at least their difference). With this information, the control inefficiency may be monetized.

Control degradation must take into account equipment configuration, flow control device performance, equipment sizing with reference to HVAC system supply and demand, system organization, distribution system interconnections and operational schedule.

Control improvement monetization is computed by comparing the actual control performance against a model of optimized control performance. The difference as could be visualized in FIG. 14 and computed and displayed in a figure like FIG. 7 will show the optimization possible if the control strategy is retro-commissioned.

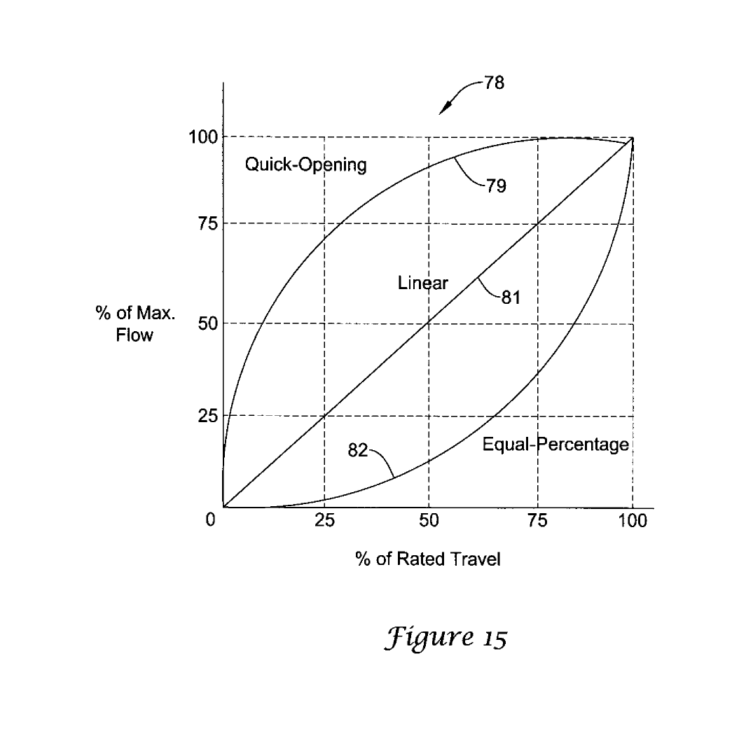

Valve characteristics are usually not linear, but should be known or determined. FIG. 15 is a graph 78 indicating a set of characteristics for an example chilled water valve. Graph 78 shows a percentage of maximum flow versus a percentage of rated travel for a quick-opening valve at curve 79, a linear valve at curve 81 and an equal-percentage valve at curve 82.

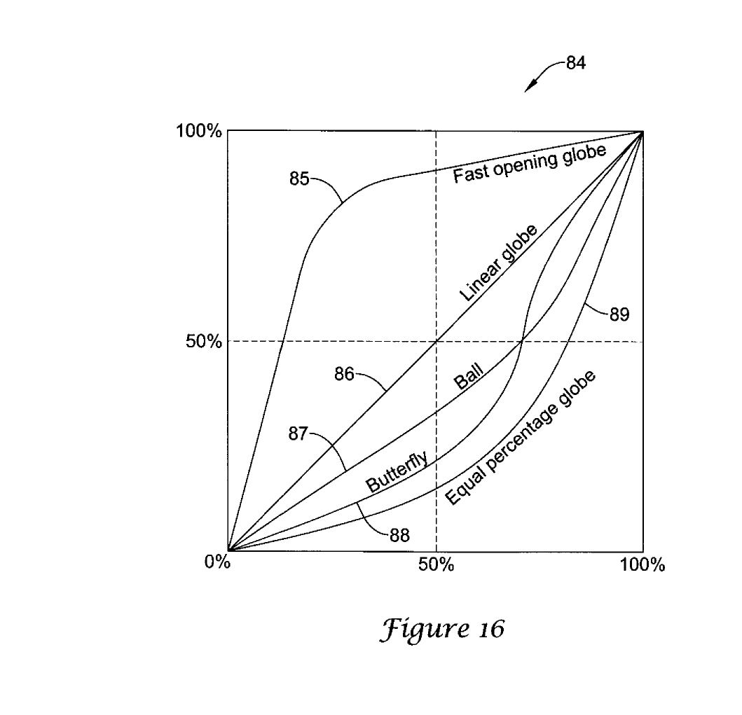

A graph 84 in FIG. 16 shows a percentage of maximum flow versus a percentage of rated travel for a fast opening globe valve at curve 85, a linear globe valve at curve 86, a ball valve at curve 87, a butterfly valve at curve 88 and an equal percentage globe vale at curve 89.

A simplified estimate of energy may be made with an assumption of a linear valve and a constant chilled water temperature increase across the cooling coil. There may be a 60 ton chiller, COP=4, 1 ton˜3.517 kW, 1 kWh=$0.1; 100% cooling coil to 60 ton=(60/4)*3.517 kW (electricity)=$5.28/hour; 50% cooling coil to 30 ton=(60/4)*1.76 kW (electricity)=$2.64/hour; and 10% cooling coil to 6 ton=(60/4)*0.35 kW (electricity)=$0.53/hour. If the range of integration shows a 2 h 13 m (133 min) time interval and its size is 54.9 (integrating percents), it may be interpreted that the unit runs 54.9/133=41.3% from 2 h 13m=54.9 min at 100% cooling output which may cost 54.9*$5.28/60=$4.83 and was off. Otherwise, it may be $4.83 per 2 h 13 m is $2.17/hour of operation. The actual behavior may be very likely different especially with a non-linear valve, so it should not necessarily be interpreted as indicated.

An internal cross check may be made with the assumptions stated as 100% cooling coil to 60 ton=60*3.517 kW (electricity)=211 kW (chilled water), 50% cooling coil to 30 ton=60*1.76 kW (electricity)=105.6 kW (chilled water), and 10% cooling coil to 6 ton=60*0.3517 kW (electricity)=21.1 kW (chilled water). For this example, one may observe (54.9/60)*211 kW=193 kW of cooling effect. The cross check involving a sum over the 2 h 13 m interval of the formula “(chilled_water_return(t)-chilled_water_supply (t))*chilled_water_mass_flow(t)*water spec_capacity” should give about 193 kW.

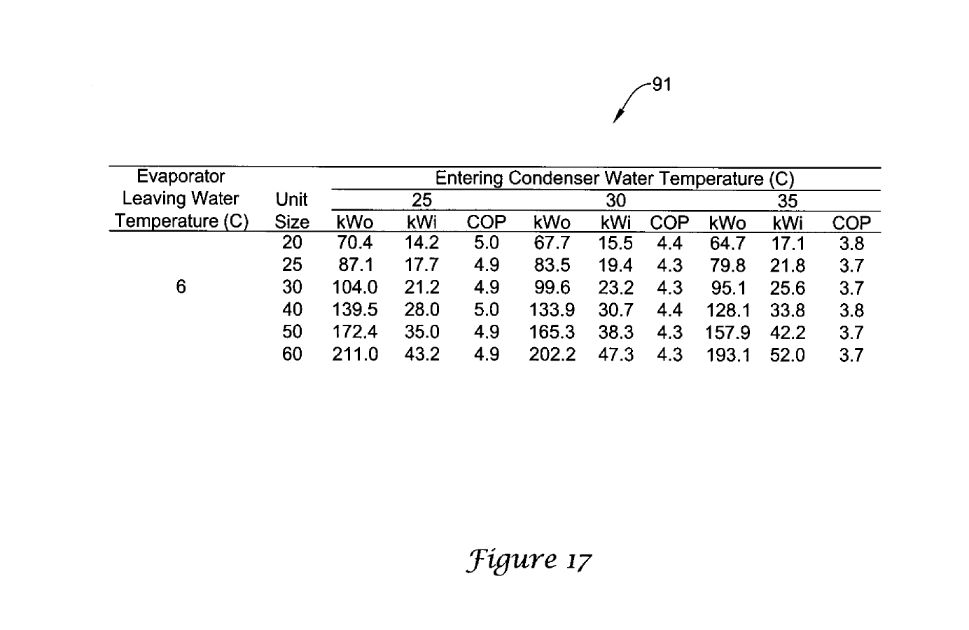

A table 91 of data from a Trane™ information sheet for an example 60 Hz water cooled scroll chiller performance data in metric units is shown in FIG. 17. The rating is said to be in accordance with an ARI Standard 550/590-98 with fouling factors of 0.0176 in the evaporator and 0.044 in the condenser. The factors may be in terms of h*ft²*° F./Btu. The factors may be converted to m2*° C./W. The kWi input is indicated for compressors only. COP =Coefficient of Performance (kWo/total kW). The total kW is indicated to include compressors and control power. Ratings are said to be based on an evaporator temperature drop of 5.6° C. The table PD-2 and associated information from Trane™ may be found at http://www.trane.com/Commercial/Uploads/Pdf/1061/cg-prc012-en.pdf, page 17.

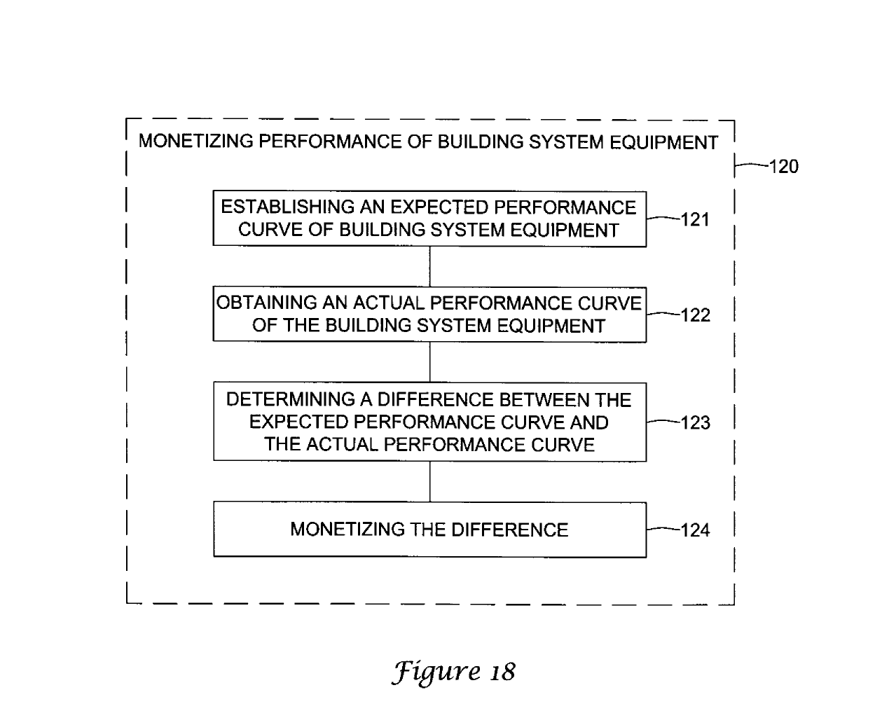

A recap may ensue. FIG. 18 is a diagram of an approach, for monetizing 120 performance of building system equipment, which may incorporate establishing 121 an expected performance curve of building system equipment, obtaining 122 an actual performance curve of the building system equipment, determining 123 a difference between the expected performance curve and the actual performance curve, and monetizing 124 the difference.

Monetizing the difference may incorporate converting the difference into a quantity of energy consumption, and determining a cost of the quantity of energy consumption. The cost of the quantity of energy consumption may be the quantity of energy consumption multiplied by a cost per quantity unit of energy as the cost per quantity unit of energy varies over time. The quantity of energy consumption may be for a time period of the actual performance curve of the building system equipment. The building system equipment may be HVAC equipment.

The expected performance curve may be for a first time period, and the actual performance curve may be over a second time period. A length of the first time period may be equal to a length of the second time period.

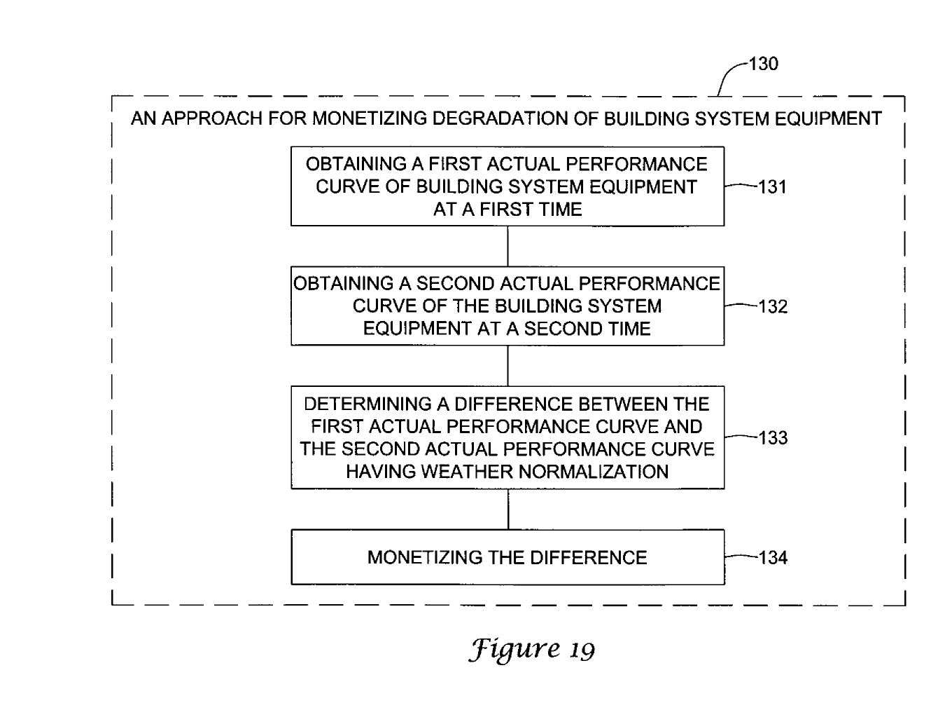

FIG. 19 is a diagram of an approach, for monetizing 130 degradation of building system equipment, which may incorporate an obtaining 131 a first actual performance curve of building system equipment at a first time, obtaining 132 a second actual performance curve of the building system equipment at a second time, determining 133 a difference between the first actual performance curve and the second actual performance curve having weather normalization, and monetizing 134 the difference.

Monetizing the difference may incorporate a converting the difference into a quantity of energy consumption, and determining a cost of the quantity of energy consumption. The cost of the quantity of energy consumption may be the quantity of energy consumption multiplied by a cost per quantity unit of energy. The quantity of energy consumption may be for a time period of the second actual performance curve of the building system equipment.

The first performance curve may be for a first time period, the second performance curve may be for a second time period, and a length of the first time period may be approximately equal to a length of the second time period.

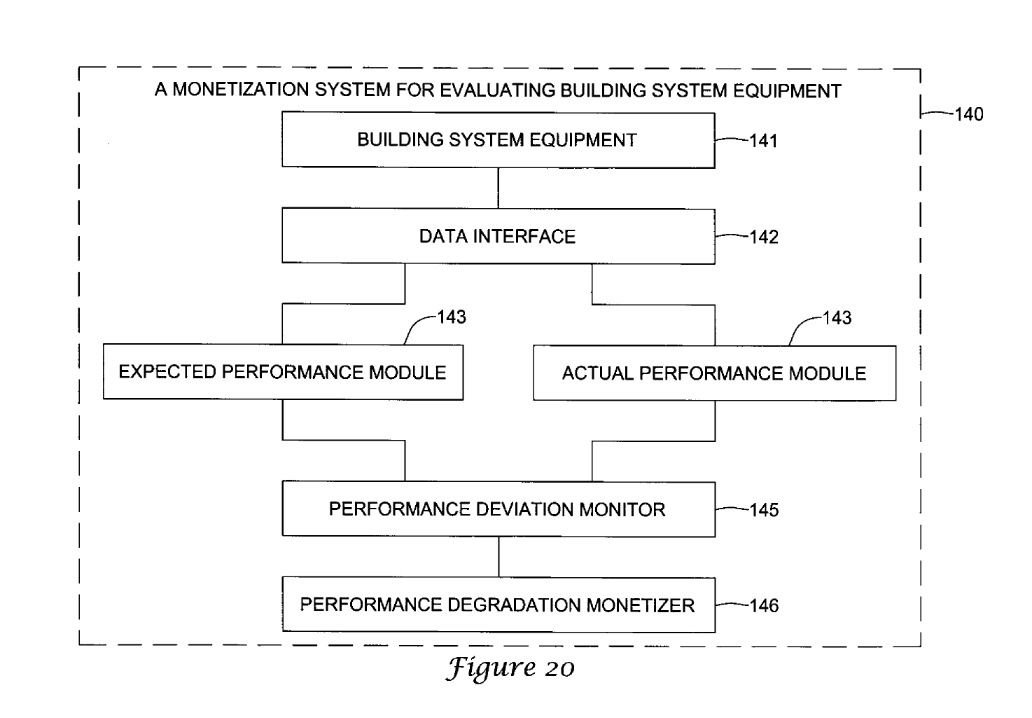

FIG. 20 is a diagram of a monetization system 140, for evaluating building system equipment 141, which may incorporate a data interface 142 connected to building system equipment, an expected performance module 143 connected to the data interface, an actual performance module 144 connected to the data interface, a performance deviation monitor 145 connected to the expected performance module and the actual performance module, and a performance degradation monetizer 146 connected to the deviation monitor. The data interface may have a data cleanser.

The system may further incorporate an equipment monitor connected to the data interface, a fault reasoning module connected to the equipment monitor, and a risk monetizer connected to the equipment monitor. The equipment monitor may be for detecting operational risks of the building system equipment.

The system may further incorporate an expected control strategy module connected to the data interface, an actual control strategy module connected to the data interface, a first control strategy deviation monitor connected to the expected control strategy module and the actual control strategy module, and a control inefficiencies monetizer connected to the control strategy deviation monitor.

The system may further incorporate a suggested optimal control strategy module connected to the actual control strategy module, a second control strategy deviation monitor connected to the actual control strategy module and the suggested optimal control strategy module, and a control improvements monetizer connected to the second control strategy deviation monitor.

The system may further incorporate an equipment observation module connected to the data interface, and an operational risk monetizer connected to the equipment observation module.

The system may further incorporate an expected control strategy module connected to the data interface, an actual control strategy module connected to the data interface, a control strategy deviation monitor connected to the expected control strategy module and the actual control strategy module, and a control inefficiencies monetizer connected to the control strategy deviation monitor, a control improvements monetizer, and a results integrator. The results integrator may be connected to the performance degradation monetizer, the operational risk monetizer, the control inefficiencies monetizer, and the control improvements monetizer.

The system may further incorporate an equipment observer module connected to the data interface, an operational risk monetizer connected to the equipment observer module, an expected control strategy module connected to the data interface, an actual control strategy module connected to the data interface, a first control strategy deviation monitor connected to the expected control strategy module and the actual control strategy module, and a control inefficiencies monetizer connected to the first control strategy deviation monitor.

The system may further incorporate a suggested optional control strategy module connected to the actual control strategy module, a second control strategy deviation monitor connected to the actual control strategy module and the suggested optimal control strategy module, a control improvements monetizer connected to the second control strategy deviation monitor, and a results integrator connected to the performance degradation monetizer, the operational risk monetizer, the control inefficiencies monetizer, and the control improvements monetizer.

In the present specification, some of the matter may be of a hypothetical or prophetic nature although stated in another manner or tense.

Although the present system and approach has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A method for informing a user of increased energy costs associated with a degradation in performance of building system heating, ventilation and air conditioning equipment, comprising:
storing a performance baseline for the building system heating, ventilation and air conditioning (HVAC) equipment in a memory;
receiving data representative of the actual performance of the building system HVAC equipment;
using a data processing system to:
compare the data representative of the actual performance of the building system HVAC equipment with the performance baseline, resulting in a measure related to a degradation in performance of the building system HVAC equipment; and
compute a measure related to increased energy costs associated with the degradation in performance of the building system HVAC equipment; and
displaying the measure related to increased energy costs associated with the degradation in performance of the building system HVAC equipment on a display.

2. The method of claim 1, wherein the data representative of the actual performance of the building system HVAC equipment is updated over time, and the comparing step is repeated over time resulting in an updated measure related to the degradation in performance of the building system HVAC equipment over time.

3. The method of claim 2, wherein the building system HVAC equipment is controlled using a control strategy, and wherein the method further incorporates automatically changing the control strategy over time based, at least in part, on the updated measure related to the degradation in performance of the building system HVAC equipment.

4. The method of claim 2, further comprises trending the updated measure related to the degradation in performance of the building system HVAC equipment.

5. The method of claim 4, further comprising making a prediction of when a fault might occur in the building system HVAC equipment based, at least in part, on the trend.

6. The method of claim 4, further comprising making a prediction of when preventative maintenance of the building system HVAC equipment should occur based, at least in part, on the trend.

7. The method of claim 2, further comprising repeating the computing step over time resulting in an updated increased energy costs associated with the degradation in performance of the building system HVAC equipment over time.

8. The method of claim 7, further comprises trending the updated increased energy costs associated with the degradation in performance of the building system HVAC equipment.

9. The method of claim 1, wherein the measure related to increased energy costs is expressed in terms of a monetary value.

10. The method of claim 1, wherein the building system HVAC equipment incorporates a plurality of building system HVAC components, and wherein the method further comprises identifying one or more of the building system HVAC components that are likely the source of at least some of the degradation in performance of the building system HVAC equipment.

11. The method of claim 1, further comprising identifying one or more faults in the building system HVAC equipment that are likely the source of at least some of the degradation in performance of the building system HVAC equipment.

12. A method for informing a user of increased energy costs associated with a degradation in performance of building system equipment, comprising:
storing a performance baseline for the building system equipment in a memory;
repeatedly receiving data representative of the actual performance of the building system equipment;
using a data processing system to:
repeatedly compare the data representative of the actual performance of the building system equipment with the performance baseline, resulting in a series of measures related to a degradation in performance of the building system equipment over time; and
repeatedly compute a measure related to increased energy costs associated with the degradation in performance of the building system equipment, resulting in a series of measures related to increased energy costs associated with the degradation in performance of the building system equipment over time; and
displaying the measures related to increased energy costs associated with the degradation in performance of the building system equipment on a display over time, wherein the measures related to increased energy costs are expressed in terms of a monetary value.

13. The method of claim 12, wherein the building system equipment incorporates a plurality of building system heating, ventilation and air conditioning and lighting components, and wherein the method further comprises identifying one or more of the building system components that are likely the source of at least some of the degradation in performance of the building system equipment.

14. The method of claim 12, further comprising:
identifying one or more faults in the building system equipment that are likely the source of at least some of the degradation in performance of the building system equipment; and
performing diagnostics of the one or more faults.

15. The method of claim 12, wherein the building system equipment incorporates a plurality of building system components, and wherein the method further comprises:
identifying one or more of the building system components that are likely the source of at least some of the degradation in performance of the building system equipment; and
identifying one or more faults in the building system equipment that are likely the source of at least some of the degradation in performance of the building system equipment.

16. The method of claim 12, wherein the building system equipment is controlled using a control strategy, and wherein the method further incorporates automatically changing the control strategy over time based, at least in part, on the measures related to the degradation in performance of the building system equipment.

17. The method of claim 12, further comprises trending the measures related to the degradation in performance of the building system equipment.

18. The method of claim 17, further comprising making a prediction of when a fault might occur in the building system equipment based, at least in part, on the trend.

19. The method of claim 17, further comprising making a prediction of when preventative maintenance of the building system equipment should occur based, at least in part, on the trend.

20. A data processing system for informing a user of increased energy costs associated with a degradation in performance of building system equipment, comprising:
a memory for storing a performance baseline for the building system equipment;
a data interface connected to building system equipment for receiving data representative of the actual performance of the building system equipment;
a performance deviation monitor for comparing the data representative of the actual performance of the building system equipment with the performance baseline, resulting in a measure related to a degradation in performance of the building system equipment; and
a performance degradation monetizer for computing a measure related to increased energy costs associated with the degradation in performance of the building system equipment; and
a display for displaying the measure related to increased energy costs associated with the degradation in performance of the building system equipment on a display.
